(19) United States
(12) Patent Application Publication
(10) Pub. No.: US 2013/0215089 A1
(43) Pub. Date: Aug. 22, 2013

(54) Gate Driving Circuit, Driving Method, and LCD System

(71) Applicant: Jinjie Wang, Shenzhen (CN)

(72) Inventor: Jinjie Wang, Shenzhen (CN)

(21) Appl. No.: 13/505,498

(22) PCT Filed: Apr. 5, 2012
(86) PCT No.: PCT/CN2012/073515

§ 371 Date: May 2, 2012

(30) Foreign Application Priority Data
Feb. 16, 2012 (CN) 20120034164.7

(51) Int. Cl. G09G 3/36; G06F 3/038

(52) U.S. Cl. 345/204; 345/92

(57) ABSTRACT

The invention discloses a gate driving circuit, a driving method thereof, and an LCD system. The gate driving circuit includes gate ICs and scan lines; each fanout of the gate ICs is at least connected with three controllable switches for controlling more than three scan lines; each controllable switch is connected with one scan line. In the invention, the number of the gate ICs is decreased; the cost is reduced; the realization of the design of the narrow frame of the LCD panel is facilitated. Meanwhile, the number of the scan lines corresponding to one fanout can be flexibly controlled by adjusting the number of the controllable switches. Thus, various different configurations are realized in a simple embodiment, and the development cost is reduced.

### TECHNICAL FIELD

The invention relates to the field of liquid crystal displays (LCDs), and more particularly to a gate driving circuit, a driving method, and an LCD system.

### BACKGROUND

An LCD system includes scan lines, data lines, and TFTs (Thin Film Transistors); the scan lines are connected to gates of the TFTs; and the data lines are connected to sources of the TFTs. The number of the scan lines and the data lines of an LCD system forms the resolution of the LCD system. Using a product having a resolution of M×N as an example, in a single gate driving mode, the number of panel gate fanouts and the number of source fanouts are N and 3M, respectively. If the number of channels of gate ICs and the number of channels of source ICs are a and b, respectively, the product needs N/a gate ICs and 3M/b source ICs. The higher the resolution of the product is, the larger the number of the fanouts is; and then, the space occupied by the fanouts and the number of ICs to be driven also increase.

Chinese Pat. Pub. No. CN101707047A, published on May 12, 2010, discloses a driving circuit of saving the number of the gate ICs. The invention provides a driving circuit of saving the number of the gate ICs. A group of driving circuit is added between the gate ICs and the scan lines of the LCD panel. By the driving circuit, the number of the gate ICs of the LCD panel under the mode of double gates keeps the same as the number of the gate ICs under the mode of a single gate. The driving circuit of the invention can save the number of the gate chips when the driving mode of the double gates is used for manufacturing the LCD panel. The invention can save cost as compared with the prior art. The driving circuit makes each scan line receive a low level signal after finishing a high level signal, so that the signal state of each scan line is clearer. Because an interlocking design is needed among the first control switch to the third control switch in the invention, thus the number of controllable scan lines is greatly restricted, one fanout can only correspond to two scan lines. One fanout for restricting the number of the controllable scan lines in a simple and low-cost mode cannot be achieved.

### SUMMARY

In view of the above-described problems, the aim of the invention is to provide a gate driving circuit, a driving method thereof, and an LCD system capable of decreasing the number of the gate ICs and benefiting realization of a design of a narrow frame.

The aim of the invention is achieved by the following technical schemes:

A gate driving circuit comprises gate ICs and scan lines; each fanout of the gate ICs is at least connected with three controllable switches for controlling more than three scan lines; each controllable switch is connected with and controls one scan line.

Preferably, the gate driving circuit further comprises at least three control lines; the controllable switches which correspond to the fanout of each gate IC share the control lines; the control end of each controllable switch is connected with one control line. Thus, if each fanout has N controllable switches, only N control lines are required to be arranged without the need of individually designing a drive for each controllable switch of each fanout, thereby greatly simplifying the control mode.

Preferably, the other end of the scan lines connected with the controllable switches is further connected with controllable reset switches; the other end of the reset switches is connected to a low potential signal; the controllable switches and the reset switches are independently controlled; the controllable switches and the reset switches, which are connected with the same scan line, are crosswise communicated. When the current scan line drives, the corresponding reset switch keeps a cut-off state and the scan line is in a high level state. At this moment, other scan lines which correspond to the same fanout keep a low level state. Thus, the reset switches which correspond to the scan lines are in an on state. The low level signal is imported into the corresponding scan line; thus, even if the controllable switches are operated by mistake, the scan lines which correspond to the controllable switches can be forcedly kept in a low potential state and then, thereby enhancing the reliability of the driving system. Furthermore, the scan lines and the low level signal are connected by the reset switches; the scan lines can be rapidly switched to a low potential from a high potential, thereby improving the driving response speed.

Preferably, the gate driving circuit further comprises at least three reset control lines and one common low potential line; the control end of each reset switch is connected with one reset control line; the other end of each reset switch is connected to the common low potential line; and the reset switches which correspond to the fanout of each gate IC share the common low potential line. This is a specific embodiment of one reset switch. The reset switches which correspond to the controllable switches of the same column can share one reset control line. Thus, if each fanout has N reset switches, only N reset control lines are required without the need of individually designing a drive for each reset switch of each fanout, thereby greatly simplifying the control mode.

Preferably, each fanout of the gate ICs is connected with a first controllable switch, a second controllable switch, and a third controllable switch; the gate driving circuit further comprises a first control line, a second control line, and a third control line; the control end of the first controllable switch is connected to the first control line; the control end of the second controllable switch is connected to the second control line; and the control end of the third controllable switch is connected to the third control line. This is a control mode that one fanout corresponds to three scan lines.

Preferably, the other end of the scan lines connected with the controllable switches is connected with controllable reset switches; and the other end of the reset switches is connected to a low potential signal. This is an embodiment of the driving circuit that one fanout corresponds to three scan lines and the reset switches are added for enhancing the driving reliability and the response speed.

Preferably, the gate driving circuit further comprises at least three reset control lines and one common low potential line; the control end of each reset switch is connected with one reset control line; the other end of each reset switch is connected to the common low potential line. This is a specific embodiment of one reset switch. The reset switches which correspond to the controllable switches of the same column can share one reset control line. Thus, if each fanout has N reset switches, only N reset control lines are required without the need of individually designing a drive for each reset switch of each fanout, thereby greatly simplifying the control mode.

Preferably, the controllable switches are TFTs. By adopting the TFTs as the controllable switches, the TFTs can be synchronously formed when an array substrate are made, without adding additional procedures, and reducing the manufacturing cost.

A driving method of the gate driving circuit comprises the following steps:

A: successively outputting a high level by each fanout of the gate ICs within at least three continuous scan intervals; and

B: successively conducting the controllable switches which correspond to the current fanout within one scan interval when the current fanout outputs a high level.

Preferably, the other end of the scan lines connected with the controllable switches is connected with controllable reset switches; the other end of the reset switches is connected to the low potential signal; the step B further comprises: when the current controllable switch is conducted, the reset switch for controlling the same scan line is cut off; when the current controllable switch is cut off, the reset switch for controlling the same scan line is conducted. When the current scan line drives, the corresponding reset switch keeps a cut-off state and the scan line is in a high level state. At this moment, other scan lines which correspond to the same fanout keep a low level state. Thus, the reset switches which correspond to the scan lines are in an on state. The low level signal is imported into the corresponding scan line; thus, even if the controllable switches are operated by mistake, the scan lines which correspond to the controllable switches can be forcedly kept in a low potential state and then, the reliability of the driving system is enhanced. Furthermore, the scan lines and the low level signal are connected by the reset switches; the scan lines can be rapidly switched to a low potential from a high potential, thereby improving the driving response speed.

An LCD system comprises the aforementioned gate driving circuit.

Because each fanout of the gate ICs is connected with at least three controllable switches and each controllable switch controls one scan line, one fanout corresponds to more than three scan lines. In this way, if the scan lines are definite, the number of the fanouts is further decreased; accordingly, the number of the gate ICs is decreased and the cost is reduced. At the same time, space occupation is reduced along with the decrease of the fanouts; the space of a circuit board area on the gate control side of the LCD panel is saved for the design of the narrow frame. Meanwhile, the number of the scan lines corresponding to one fanout can be flexibly controlled by adjusting the number of the controllable switches. Thus, various different configurations are realized in a simple embodiment, and the development cost is reduced.

### BRIEF DESCRIPTION OF FIGURES

FIG. 1 is a conventional driving mode of scan lines and data lines;

FIG. 2 is a schematic diagram of one embodiment of the invention;

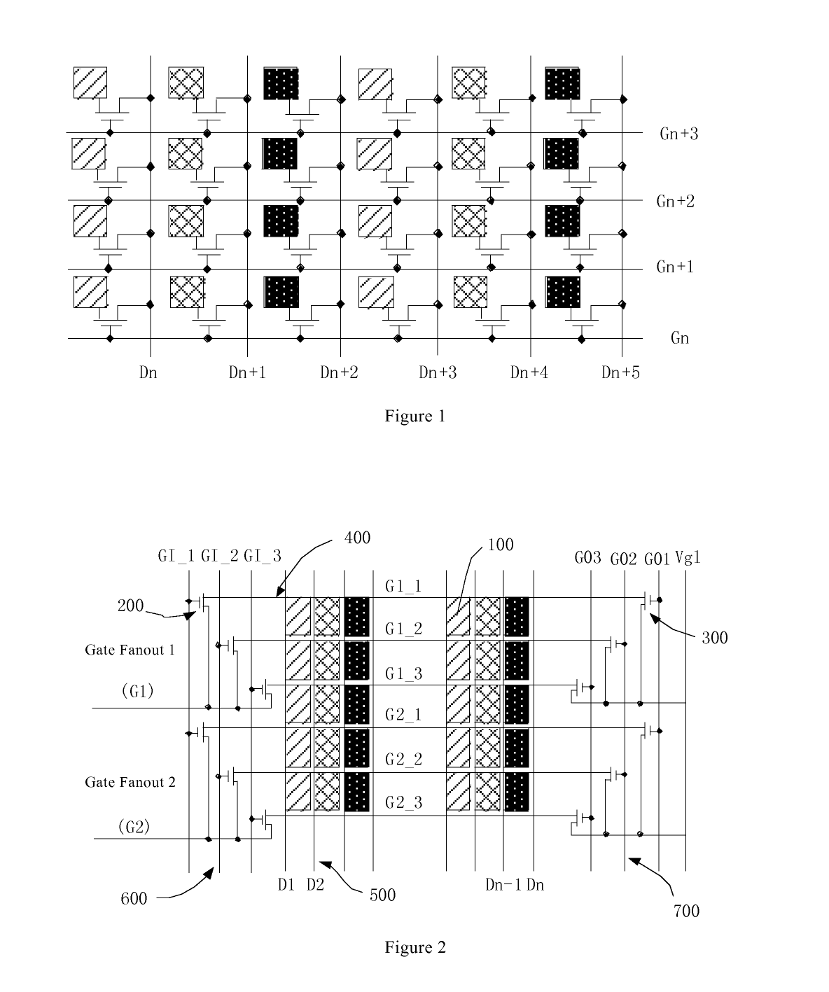

Legends: 1. LCD pixel; 200. controllable switch; 300. reset switch; 400. scan line; 500. data line; 600. control line; 700. reset control line.

### DETAILED DESCRIPTION

The invention will further be described in detail in accordance with the figures and the preferred examples.

An LCD system comprises an LCD panel and a backlight module which is positioned on the bottom of the LCD panel; the LCD panel comprises a plurality of LCD pixels 100 and crisscross scan lines 400 and data lines 500. Each LCD pixel 100 comprises a pixel electrode and a TFT connected with the pixel electrode; the gate electrode of the TFT is connected to the scan lines 400; the source electrode of the TFT is connected to the data lines 500. A gate driving circuit comprises gate ICs and scan lines 400; each fanout of the gate ICs is at least connected with three controllable switches 200; each controllable switch 200 is connected with one scan line 400.

The controllable switches 200 are controlled by control lines 600, namely the control end of each controllable switch 200 respectively connected with one control line 600; as long as the controllable switches 200 which correspond to different fanouts are positioned in the same column, the controllable switches 200 can share one control line 600. In this way, if one fanout corresponds to N scan lines 400, only N control lines 600 are needed.

To enhance the reliability and the speed of response of the gate driving circuit, the other end of the scan lines 400 connected with the controllable switches 200 can also be connected with the controllable reset switches 300 and the other end of the reset switches 300 is connected to the low potential signal. When the current scan line 400 drives, the corresponding reset switch 300 keeps a cut-off state and the scan line 400 is in a high level state. At this moment, other scan lines 400 which correspond to the same fanout keep a low level state. Thus, the reset switches 300 which correspond to the scan lines 400 are in an on state. The low level signal is imported into the corresponding scan line 400. Thus, even if the controllable switches 200 are operated by mistake, the scan lines 400 which correspond to the controllable switches 200 can be forcedly kept in a low level state and then. The reliability of the driving system is enhanced. Furthermore, the scan lines 400 and the low level signal are connected by the reset switches 300; the scan lines 400 can be rapidly switched to a low potential from a high potential, thereby improving the driving response speed.

The reset switches 300 can also adopt a control mode similar to the control switch. Reset control lines 700 with the same number as that of the control lines 600 are arranged. The control end of each reset switch 300 is connected with one reset control line 700; one common low potential line can also be arranged; the other end of each reset switch 300 is connected to the common low potential line.

The invention will further be described in detail by using the example that each fanout of the gate ICs is connected with three controllable switches 200.

In the LCD panel, a group of controllable switches 200 are arranged on the panel gate input; three controllable switches 200 in each group respectively control signal input of three scan lines 400. The controllable switches 200 on the gate output are matched with a particular signal input mode for opening and closing scan signals line by line.

As shown in FIG. 2, GI_1, GI_2 and GI_3 are control lines 600, and G1_1, G1_2, G1_3, G2_1, G2_2 and G2_3 are scan lines 400; D1, D2, Dn−1 and Dn are data lines 500; G03, G02 and G01 are reset control lines 700; Vgl is a common low potential line.

GI_1, GI_2 and GI_3 respectively input a high/low voltage and are switched with time, namely at T1, GI_1 inputs high level (H) and GI_2 and GI_3 input low level (L); at T2, GI_1 and GI_3 input L and GI_2 inputs H; at T3, GI_1 and GI_2 input L and GI_3 inputs H. Furthermore, when GI_1 inputs H, GO1 inputs L and GO2 and GO3 input H. When GI_2 inputs H, GO2 inputs L and GO1 and GO3 input H. When GI_3 inputs H, GO3 inputs L and GO1 and GO2 input H. Vgl keeps inputting L. At T1, GI_1 inputs H, and GI_2 and GI_3 input L; G1 to Gn are gate fanouts; G1 inputs H; G2 to Gn input L; GO1 inputs L; reset control lines 700, GO2 and GO3 input H; Vgl keeps L voltage.

Because GI_1 inputs H, G1 signal can be transmitted into G1_1 and the TFT which corresponds to G1_1 is opened; at this moment, GO1 inputs L; thus, Vgl signal will not be transmitted into G1_1. At the same time, GI_2 and GI_3 input L; thus, H signal of GI cannot be transmitted into G1_2 and GI_3; GO2 and GO3 input H; L signal of Vgl is transmitted into G1_2 and G1_3.

Meanwhile, G2 inputs L; because GI_1 inputs H, L voltage of GI_1 can be transmitted into G2_1; moreover, GO2 and GO3 input H, L signal of Vgl can be transmitted into G2_2 and G2_3.

Scan lines 400 which correspond to G3-Gn are similar to the aforementioned description.

At T2, GI_2 inputs H, GI_1 and GI_3 input L, GI inputs H, G2-Gn input L, GO2 inputs L, GO1 and GO3 input H, and Vgl keeps L voltage.

Because GI_2 inputs H, G1 signal can be transmitted into G1_2 and the TFT which corresponds to G1_2 is opened; at this moment, GO2 inputs L; thus, Vgl signal will not be transmitted into G1_2. At the same time, GI_1 and GI_3 input L; thus, H signal of GI cannot be transmitted into G1_1 and G1_3; GO1 and GO3 input H; L signal of Vgl is transmitted into G1_1 and G1_3.

Meanwhile, G2 inputs L; because GI_2 inputs H, L voltage of GI_2 can be transmitted into G2_2; moreover, GO1 and GO3 input H; L signal of Vgl can be transmitted into G2_1 and G2_3.

Scan lines 400 which correspond to G3-Gn are similar to the aforementioned description.

At T3, GI_3 inputs H; GI_1 and GI_2 input L; GI inputs H; G2-Gate Gn input L; GO3 inputs L; GO1 and GO2 input H; Vgl keeps L voltage.

Because GI_3 inputs H, G1 signal can be transmitted into G1_3 and the TFT which corresponds to G1_3 is opened; at this moment, GO3 inputs L; thus, Vgl signal will not be transmitted into G1_3. At the same time, GI_1 and GI_2 input L; thus, H signal of GI cannot be transmitted into G1_1 and GI_2; GO1 and GO2 input H; L signal of Vgl is transmitted into G1_1 and G1_2.

Meanwhile, G2 inputs L; because GI_3 inputs H, L voltage of GI_3 can be transmitted into G2_3; moreover, GO1 and GO2 input H; L signal of Vgl can be transmitted into G2_1 and G2_2.

Scan lines 400 which correspond to G3-Gn are similar to the aforementioned description.

Signal voltage input and output at each time is sorted as shown in Table 1:

TABLE 1

| | Input | | | | | | | | | Output | | | | | |
|---|---|---|---|---|---|---|---|---|---|---|---|---|---|---|---|
| | G1 | G2 | GI_1 | GI_2 | GI_3 | G01 | G02 | G03 | Vgl | G1_1 | G1_2 | G1_3 | G2_1 | G2_2 | G2_3 |
| T1 | H | L | H | L | L | L | H | H | L | H | L | L | L | L | L |
| T2 | H | L | L | H | L | H | L | H | L | L | H | L | L | L | L |
| T3 | H | L | L | L | H | H | H | L | L | L | L | H | L | L | L |
| T4 | L | H | H | L | L | L | H | H | L | L | L | L | H | L | L |
| T5 | L | H | L | H | L | H | L | H | L | L | L | L | L | H | L |
| T6 | L | H | L | L | H | H | H | L | L | L | L | L | L | L | H |

It is shown that when a novel panel is employed to match with a designed signal sequence, the scan lines 400 can be successively opened and closed; the functions of reducing the number of ICs and saving the cost are achieved by applying only ⅓ number of gate fanouts.

The driving effect can also be achieved by the mode of adding more controllable switches 200. For example, the number of the controllable switches 200 is added to four, five or more; the purpose of reducing the gate fanouts can be achieved only according to the aforementioned driving mode.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A gate driving circuit, comprising: gate ICs and scan lines; wherein each fanout of said gate ICs is at least connected with three controllable switches for controlling more than three scan lines; and each of said controllable switches is connected with and controls one scan line.

2. The gate driving circuit of claim 1, wherein said gate driving circuit further comprises at least three control lines; the controllable switches which correspond to the fanout of each gate IC share said control lines; and the control end of each of said controllable switch is connected with one said control line.

3. The gate driving circuit of claim 3, wherein the other end of said scan lines connected with the controllable switches is further connected with the controllable reset switches; the other end of said reset switches is connected to a low level signal; said controllable switches and said reset switches are independently controlled; and the controllable switches and the reset switches, which are connected with the same scan line, are crosswise communicated.

4. The gate driving circuit of claim 3, wherein the gate driving circuit further comprises at least three reset control lines and one common low potential line; the control end of each of said reset switch is connected with one reset control line; the other end of each of said reset switches is connected to the common low potential line; and the reset switches which correspond to the fanout of each gate IC share the common low potential line.

5. The gate driving circuit of claim 1, wherein each fanout of said gate ICs is connected with a first controllable switch, a second controllable switch, and a third controllable switch; said gate driving circuit further comprises a first control line, a second control line, and a third control line; the control end of said first controllable switch is connected to the first control line; the control end of said second controllable switch is connected to the second control line; the control end of said third controllable switch is connected to the third control line.

6. The gate driving circuit of claim 5, wherein the other end of said scan lines connected with the controllable switches is connected with controllable reset switches; and the other end of said reset switches is connected to a low potential signal.

7. The gate driving circuit of claim 6, wherein said gate driving circuit further comprises at least three reset control lines and one common low potential line; the control end of each of said reset switches is connected with one of said reset control line; and the other end of each of said reset switches is connected to the common low potential line.

8. The gate driving circuit of claim 1, wherein said controllable switches are TFTs.

9. A method for driving the gate driving circuit of claim 1, comprising:
A: successively outputting a high level by each fanout of the gate ICs within at least three continuous scan intervals; and
B: successively conducting the controllable switches which correspond to the current fanout within one scan interval when the current fanout outputs a high level.

10. The method for driving the gate driving circuit of claim 9, wherein the other end of said scan lines connected with the controllable switches is connected with controllable reset switches; the other end of said reset switches is connected to a low potential signal; said step B further comprises: when the current controllable switch is conducted, the reset switch for controlling the same scan line is cut off; and when the current controllable switch is cut off, the reset switch for controlling the same scan line is conducted.

11. An LCD system, comprising: a gate driving circuit; wherein said gate driving circuit comprises gate ICs and scan lines; each fanout of said gate ICs is at least connected with three controllable switches for controlling more than three scan lines; each of said controllable switches is connected with and controls one scan line.

12. The LCD system of claim 11, wherein said gate driving circuit further comprises at least three control lines; the controllable switches which correspond to the fanout of each gate IC share said control lines; the control end of each of said controllable switches is connected with one of said control lines.

13. The LCD system of claim 11, wherein the other end of said scan lines connected with the controllable switches is further connected with controllable reset switches; the other end of said reset switches is connected to a low potential signal; said controllable switches and said reset switches are independently controlled; and the controllable switches and the reset switches, which are connected with the same scan line are crosswise communicated.

14. The LCD system of claim 13, wherein said gate driving circuit further comprises at least three reset control lines and one common low potential line; the control end of each of said reset switches is connected with one reset control line; the other end of each of said reset switches is connected to the common low potential line; the reset switches which correspond to the fanout of each gate IC share said common low potential line.

15. The LCD system of claim 11, wherein each fanout of said gate ICs is connected with a first controllable switch, a second controllable switch, and a third controllable switch; said gate driving circuit further comprises a first control line, a second control line, and a third control line; the control end of said first controllable switch is connected to the first control line; the control end of said second controllable switch is connected to the second control line; and the control end of said third controllable switch is connected to the third control line.

16. The LCD system of claim 15, wherein the other end of said scan lines connected with the controllable switches is connected with controllable reset switches; and the other end of said reset switches is connected to a low potential signal.

17. The LCD system of claim 16, wherein the gate driving circuit further comprises at least three reset control lines and one common low potential line; the control end of each of said reset switches is connected with one said reset control line; and the other end of each of said reset switches is connected to the common low potential line.

18. The LCD system of claim 11, wherein said controllable switches are TFTs.
